(19) United States
(12) Patent Application Publication
(10) Pub. No.: US 2020/0106162 A1
(43) Pub. Date: Apr. 2, 2020

(54) ELECTRONIC DEVICE

(71) Applicant: Lenovo (Beijing) Co., Ltd., Beijing (CN)

(72) Inventors: Jian REN, Beijing (CN); Shuangjie WU, Beijing (CN); Wei WANG, Beijing (CN)

(21) Appl. No.: 16/579,511

(22) Filed: Sep. 23, 2019

(30) Foreign Application Priority Data
Sep. 30, 2018 (CN) 201811161168.5

(51) Int. Cl. H01Q 1/24; H01Q 1/52; H01Q 21/30

(52) U.S. Cl. CPC H01Q 1/243; H01Q 21/30; H01Q 1/521

(57) ABSTRACT

The present disclosure provides an electronic device including a metal frame. The metal frame provides one or more antennas including a first antenna. The range of an operating frequency band of the first antenna at least includes a 5 GHz band to allow the electronic device to support a mobile communication network.

### CROSS-REFERENCES TO RELATED APPLICATIONS

This application claims priority of Chinese Patent Application No. 201811161168.5, filed on Sep. 30, 2018, the entire contents of which are hereby incorporated by reference.

### FIELD OF THE DISCLOSURE

The present disclosure generally relates to the field of antenna technology and, more particularly, relates to an electronic device.

### BACKGROUND

At present, the design of terminal antennas with an operating frequency band of 5 GHz mainly adopts the laser-direct-structuring (LDS) technology to realize the antenna design. However, due to the high price of the LDS process, the cost of terminal antennas with an operating frequency band of 5 GHz is high. The disclosed electronic device is directed to solve one or more problems set forth above and other problems.

### BRIEF SUMMARY OF THE DISCLOSURE

One aspect of the present disclosure provides an electronic device. The electronic device includes a metal frame. The metal frame provides one or more antennas. The one or more antennas includes a first antenna. The range of an operating frequency band of the first antenna at least includes a 5 GHz band to allow the electronic device to support a mobile communication network.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic view of an electronic device according to some embodiments of the present disclosure;

FIG. 2 illustrates a schematic view of an electronic device according to some embodiments of the present disclosure;

FIG. 3 illustrates a schematic view of an electronic device according to some embodiments of the present disclosure;

FIG. 4 illustrates a schematic diagram of structural sizes of an electronic device according to some embodiments of the present disclosure;

FIG. 5 illustrates a schematic circuit diagram of a fourth antenna according to some embodiments of the present disclosure;

FIG. 6 illustrates an operation-efficiency graph according to some embodiments of the present disclosure;

FIG. 7 illustrates a schematic view of an electronic device according to some embodiments of the present disclosure;

FIG. 8 illustrates a schematic circuit diagram of a matching circuit according to some embodiments of the present disclosure;

FIG. 9 illustrates a return-loss graph according to some embodiments of the present disclosure;

FIG. 10 illustrates a return-loss graph of a first antenna according to some embodiments of the present disclosure;

FIG. 11 illustrates an operation-efficiency graph according to some embodiments of the present disclosure; and

FIG. 12 illustrates an operation-efficiency graph of a first antenna according to some embodiments of the present disclosure.

### DETAILED DESCRIPTION

Reference will now be made in detail to various embodiments of the disclosure, which are illustrated in the accompanying drawings. Wherever possible, the same reference numbers will be used throughout the drawings to refer to the same or like parts. The described embodiments are some but not all of the embodiments of the present disclosure. Based on the disclosed embodiments and without inventive efforts, persons of ordinary skill in the art may derive other embodiments consistent with the present disclosure, all of which are within the scope of the present disclosure.

The disclosed embodiments in the present disclosure are merely examples for illustrating the general principles of the disclosure. Any equivalent or modification thereof, without departing from the spirit and principle of the present disclosure, falls within the true scope of the present disclosure.

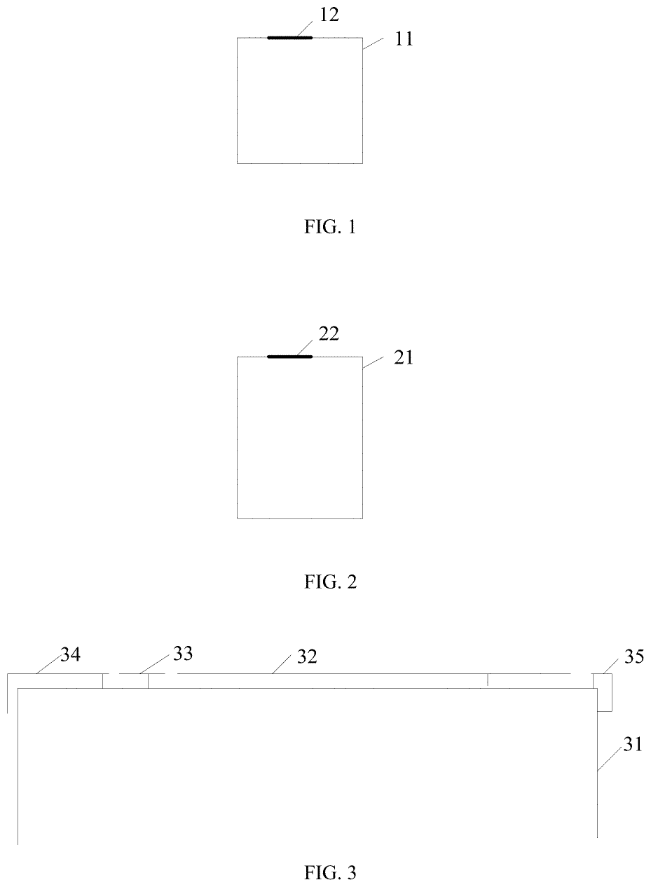

The present disclosure provides an electronic device. FIG. 1 illustrates a schematic view of an electronic device according to some embodiments of the present disclosure.

Referring to FIG. 1, the electronic device may include a metal frame 11 and a first antenna 12. The metal frame 11 may be used to provide one or more antennas. The one or more antennas may include a first antenna, and the range of the operating frequency band of the first antenna may at least include a 5 GHz band to allow the electronic device to support the mobile communication network.

The metal frame 11 may provide one antenna, two antennas, or even more antennas. It should be noted that no matter how many antennas are provided by the metal frame 11, at least one of the antennas provided by the metal frame may be the first antenna.

Further, the range of the operating frequency band of the first antenna may at least include a 5 GHz band. That is, the operating frequency band of the first antenna may only include a 5 GHz band, may include a 5 GHz band and a 4 GHz band, may include a 5 GHz band, a 6 GHz band, and a 7 GHz band, or may include a 4 GHz band, a 5 GHz band, a 6 GHz band, and a 7 GHz band. It should be noted that regardless of the exact range that the operating frequency band of the first antenna covers, the range covered by the operating frequency band of the first antenna may at least include 5 GHz.

The metal frame may be used to provide one or more antennas, such that the electronic device may at least be able to support the mobile communication network through the one or more antennas. In some embodiments, the mobile communication network may be the second generation mobile communication network, the third generation mobile communication network, the fourth generation mobile communication network, or the fifth generation mobile communication network. In other embodiments, the mobile communication network may include two or more generations of mobile communication networks.

Further, because the range of the operating frequency band corresponding to the fourth generation mobile communication network, the third generation mobile communication network, and the second generation mobile communication network does not reach 5 GHz, when the range of the operating frequency band of the first antenna at least includes a 5 GHz band, the electronic device may at least be able to support the fifth generation mobile communication network.

According to the disclosed electronic device, the electronic device may include a metal frame, and the metal frame may be used to provide one or more antennas. The one or more antennas may at least include a first antenna. The range of the operating frequency band of the first antenna may at least include a 5 GHz band, such that the electronic device may be able to support mobile communication network. The present solution provides at least a first antenna on the metal frame, and the range of the operating frequency band of the first antenna at least includes a 5 GHz band, such that the electronic device is provided with an antenna with an operating frequency band of 5 GHz on the metal frame. Therefore, the disclosed electronic device may be able to avoid using the LDS technology to implement an antenna with an operating frequency band of 5 GHz, and thus may save the production cost of the antenna.

The present disclosure provides an electronic device. FIG. 1 illustrates a schematic view of an electronic device according to some embodiments of the present disclosure.

Referring to FIG. 1, the electronic device may include a metal frame 11 and a first antenna 12. In addition to the same structure as described in the above embodiment, the first antenna 12 in the present embodiment may be used to allow the electronic device to support the fifth generation mobile communication network, and the first antenna may be one of the four antennas in the electronic device for supporting the fifth generation mobile communication network.

In some embodiments, the first antenna may allow the electronic device to support the fifth generation mobile communication network. In a case where the electronic device is able to support the fifth generation mobile communication network, the electronic device may include at least four antennas. The at least four antennas may all be used to support the fifth generation mobile communication network. In a case where the number of antennas in an electronic device is less than four, the electronic device may not be able to support the fifth generation mobile communication network.

In some embodiments, the electronic device may include four antennas for allowing the electronic device to support the fifth generation mobile communication network. The four antennas may at least include a first antenna, and the first antenna may be disposed on the metal frame of the electronic device. That is, at least one antenna among the four antennas that are used to allow the electronic device to support the fifth generation mobile communication network may be disposed on the metal frame of the electronic device, and antennas other than the at least one antenna may be implemented using the LDS technology, or may be disposed on the metal frame. For example, the first antenna among the four antennas that are used to allow the electronic device to support the fifth generation mobile communication network may be disposed on the metal frame, and the three antennas other than the first antenna may be implemented using the LDS technology. Alternatively, with the first antenna disposed on the metal frame, among the three antennas other than the first antenna, one or two antennas of may be implemented using the LDS technology and the remaining antennas may be disposed on the metal frame.

In some embodiments, the electronic device may include four antennas for allowing the electronic device to support the fifth generation mobile communication network, and the four antennas may include one or more antennas disposed on the metal frame of the electronic device. Moreover, besides the first antenna, the one or more antennas may also include the three antennas, among the four antennas, that are different from the first antenna.

The one or more antennas may be disposed on the metal frame. Among the four antennas for allowing the electronic device to support the fifth generation mobile communication network, the one or more antennas may also include the three antennas that are different from the first antenna. Accordingly, because the one or more antennas includes the first antenna as well as the other three antennas, the four antennas for allowing the electronic device to support the fifth generation mobile communication network may all be disposed on the metal frame of the electronic device.

In some embodiments, the metal frame of the electronic device may be used to at least provide four antennas, and the four antennas may all be used to allow the electronic device to support the fifth generation mobile communication network. As such, the four antennas for allowing the electronic device to support the fifth generation mobile communication network may all be disposed on the metal frame of the electronic device, and may not need to be implemented using the LDS technology, which may save the production cost of the 5G antenna.

According to the disclosed electronic device, the electronic device may include a metal frame, and the metal frame may be used to provide one or more antennas. The one or more antennas may include a first antenna. The range of the operating frequency band of the first antenna may at least include a 5 GHz band. The first antenna may be used to allow the electronic device to support the fifth mobile communication network. The first antenna may be one of four antennas that allow the electronic device to support the 5G communication network. The present solution provides at least a first antenna on the metal frame, and the range of the operating frequency band of the first antenna at least includes a 5 GHz band. In addition, the first antenna is able to allow the electronic device to support 5G communication network, such that the electronic device is provided with an antenna with an operating frequency band of 5 GHz on the metal frame. Therefore, the disclosed electronic device may be able to avoid using the LDS technology to implement an antenna with an operating frequency band of 5 GHz, and thus may save the production cost of the antenna.

The present disclosure provides an electronic device. FIG. 1 illustrates a schematic view of an electronic device according to some embodiments of the present disclosure.

Referring to FIG. 1, the electronic device may include a metal frame 11 and a first antenna 12. In addition to the same structure as described in the above embodiment, the range of the operating frequency band of the first antenna 11 in the present embodiment may allow the electronic device to support two or more generations of mobile communication networks. The two or more generations of mobile communication networks may include the fifth generation mobile communication network.

Because the range of the operating frequency band of the first antenna at least includes a 5 GHz band, the first antenna may be able to allow the electronic device to at least support the fifth generation mobile communication network.

In some embodiments, the range of the operating frequency band of the first antenna may be wide enough to cover an operating frequency band of the fourth generation mobile communication network, and accordingly, the first antenna may also be able to allow the electronic device to support the fourth generation mobile communication network. In another embodiment, the range of the operating frequency band of the first antenna may be wide enough to cover operating frequency band of the third generation mobile communication network and the fourth generation mobile communication network, and accordingly, the first antenna may also be able to allow the electronic device to support both the third generation mobile communication network and the fourth generation mobile communication network. Further, the range of the operating frequency band of the first antenna may be wide enough to also cover an operating frequency band of a sixth generation mobile communication network, and accordingly, the first antenna may also be able to allow the electronic device to support the sixth generation mobile communication network. The sixth generation mobile communication network may have an operating frequency band higher than a 5 GHz band that is adopted for the fifth generation mobile communication network.

For example, the operating frequency band of the first antenna may include a range approximately from 3 GHz to 6 GHz. Corresponding to the operating frequency band of the first antenna covering the range approximately from 3 GHz to 6 GHz, the electronic device may be able to support the fifth generation mobile communication network. In another example, the range of the operating frequency band of the first antenna may cover a 2 GHz band, and accordingly, the electronic device may be able to support the fourth generation mobile communication network.

According to the disclosed electronic device, the electronic device may include a metal frame, and the metal frame may be used to provide one or more antennas. The one or more antennas may include a first antenna. The range of the operating frequency band of the first antenna may at least include a 5 GHz band, and the electronic device may support at least two generations of mobile communication networks. The at least two generations of mobile communication networks may include the fifth generation mobile communication network. The present solution provides at least a first antenna on the metal frame, and the range of the operating frequency band of the first antenna at least includes a 5 GHz band, such that the electronic device is provided with an antenna with an operating frequency band of 5 GHz on the metal frame. Therefore, the disclosed electronic device may be able to avoid using the LDS technology to implement an antenna with an operating frequency band of 5 GHz, and thus may save the production cost of the antenna.

The present disclosure provides an electronic device. FIG. 2 illustrates a schematic view of an electronic device according to some embodiments of the present disclosure.

Referring to FIG. 2, the electronic device may include a metal frame 21 and a first antenna 22. The metal frame 21 may be used to provide one or more antennas. The one or more antennas may include a first antenna 22, and the range of the operating frequency band of the first antenna 22 may at least include a 5 GHz band to allow the electronic device to support the mobile communication network.

In some embodiments, the first antenna 22 may be disposed on a short side of the metal frame 21. For example, the first antenna 22 may be a first metal part located on a side surface of the short side of the metal frame 21.

In some embodiments, the first antenna may be disposed on the metal frame of the electronic device. The electronic device may not have a square shape but a rectangular shape, that is, the metal frame may be a rectangle. Therefore, the electronic device may have long sides and short sides. For different electronic devices, the requirements for the setting positions of the antenna may also be different. By disposing the antenna at different positions of the electronic device, the corresponding signal strength of the antenna may also be different.

For example, the first antenna may be disposed on the top side of the electronic device. For different electronic devices, the side corresponding to the top may be a long side or a short side. In some embodiments, the electronic device may be a mobile phone, and the antenna may be disposed on the top side of the mobile phone. That is, the antenna may be disposed at a position corresponding to a short side of the metal frame. In another embodiment, the electronic device may be a television, and the antenna may be disposed on the top side of the television. That is, the antenna may be disposed at a position corresponding to a long side of the metal frame.

In some embodiments, the first antenna may be disposed on a short side of the metal frame of the electronic device. For example, the first antenna may be a part of the metal on the side surface of the short side of the metal frame. The first antenna may not occupy the entire side surface of the short side of the metal frame, instead the first antenna may only occupy a part of the side surface of the short side. That is, the first antenna may be a first metal part.

Further, the one or more antennas may include four antennas. The first antenna may be one of the four antennas. The four antennas may correspond to four metal parts of the metal frame, respectively. The four metal parts may be discontinuously disposed, that is, the four metal parts may not be electrically connected to each other. The four metal parts may form a side surface of the short side of the metal frame.

In some embodiments, the metal frame may be used to provide four antennas. That is, the four antennas may all be disposed on the metal frame, and may correspond to different positions on the metal frame. The four antennas may be disposed on a same side of the metal frame or may be disposed on different sides.

For example, the first antenna may be disposed on a first short side of the metal frame, a second antenna may be disposed on a second short side of the metal frame, a third antenna may be disposed on a first long side of the metal frame, and a fourth antenna may be disposed on a second long side of the metal frame. In another example, the first antenna may be disposed on a first short side of the metal frame, and a second antenna, a third antenna, and a fourth antenna may be disposed on a long side of the metal frame.

In some embodiments, the four antenna may respectively correspond to four metal parts of the metal frame. Each metal part may not be directly connected to any of the other three metal parts. That is, the four metal parts may not be arranged in a continuous manner, and every two adjacent antennas may be spaced apart from each other with an interval between the two adjacent antennas.

Further, the four metal parts corresponding to the four antennas may form the side surface of a short side of the metal frame. For example, the four metal parts of the metal frame that respectively correspond to the four antennas, together with the metal parts that space adjacent antennas may form a side surface of the short side of the metal frame. That is, the four antennas may all be disposed on a short side of the metal frame. In another example, two or more antennas among the four antennas may be disposed on a short side of the metal frame, and among the remaining antennas of the four antennas, at least one antenna may have a portion disposed on the short side of the metal frame and another portion disposed on a long side of the metal frame that is adjacent to the short side.

Alternatively, one or more metal parts among the four metal parts that respectively correspond to the four antennas, together with the metal parts that space the one or more antennas may form a side surface of the short side of the metal frame. That is, a short side of the metal frame may be formed by one antenna, two antennas, or three antennas together with the metal parts that space adjacent antennas. For example, a short side of the metal frame may be formed by the first antenna, a second antenna, a third antenna, together with the metal parts spacing the three antennas. In another example, a short side of the metal frame may be formed by the first antenna, a second antenna, together with the metal part between the two antennas. Alternatively, the first antenna together with the metal parts spacing the first antenna from other antennas may form a short side of the metal frame; or the first antenna may form a short side of the metal frame.

According to the disclosed electronic device, the electronic device may include a metal frame, and the metal frame may be used to provide one or more antennas. The one or more antennas may include a first antenna. The range of the operating frequency band of the first antenna may at least include a 5 GHz band, such that the electronic device may be able to support mobile communication network. The first antenna is disposed on a short side of the metal frame, and the first antenna is a first metal part on the side surface of the short side of the metal frame. The present solution provides at least a first antenna on the metal frame, and the range of the operating frequency band of the first antenna at least includes a 5 GHz band, such that the electronic device is provided with an antenna with an operating frequency band of 5 GHz on the metal frame. Therefore, the disclosed electronic device may be able to avoid using the LDS technology to implement an antenna with an operating frequency band of 5 GHz, and thus may save the production cost of the antenna.

The present disclosure provides an electronic device. FIG. 3 illustrates a schematic view of an electronic device according to some embodiments of the present disclosure.

Referring to FIG. 3, the electronic device may include a metal frame 31, a first antenna 32, a second antenna 33, a third antenna 34, and a fourth antenna 35. In addition to the same structure as described in the above embodiment, the electronic device may be further provided with a second antenna 33, a third antenna 34, and a fourth antenna 35.

In some embodiments, the first antenna 32 may be a first metal part, and the two terminals of the first metal part may not be grounded. The feeding point of the first antenna 32 may be located at a first position of the first metal part, and the first metal part may be divided into a first branch and a second branch by the feeding point of the first antenna. The first branch and the second branch of the first metal part may be asymmetric with each other.

The second antenna 33 may be a second metal part, and the two terminals of the second metal part may not be grounded. The feeding point of the second antenna 33 may be located at a second position of the second metal part, and the second metal part may be divided into a first branch and a second branch by the feeding point of the second antenna. The first branch and the second branch of the second metal part may be symmetric to each other.

The third antenna 34 may be a third metal part. In addition, one terminal of the third metal part may be grounded and the other terminal may serve as a feeding point of the third antenna 34.

The fourth antenna 35 may be a fourth metal part. In addition, one terminal of the fourth metal part may be grounded and the other terminal may serve as a feeding point of the fourth antenna 35.

In a case where both terminals of an antenna are not grounded and the feeding point divides the antenna into two branches that are asymmetric with each other, the antenna may be made in a monopole form, e.g. the antenna may be a magnetic monopole antenna. For example, the first antenna may be in a monopole form.

In a case where the two terminals of the antenna are not grounded, and the feeding point divides the antenna into two branches that are symmetric to each other, the antenna may be made in a dila form, e.g. the antenna may be a T-type antenna. For example, the second antenna may be in a dila form.

In a case where one terminal of the antenna is grounded and the other terminal serves as the feeding point of the antenna, the antenna may be made in a loop shape, e.g. the antenna may be a loop antenna. For example, the third antenna and/or the fourth antenna may be made in the loop form.

In some embodiments, the feeding point of the second antenna may divide the second metal part into a first branch and a second branch, and the first branch and the second branch may be symmetric structures or asymmetric structures. Whether the first branch and the second branch are symmetric structures or asymmetric structures may be determined by the design requirements of the electronic device. Therefore, the second antenna may be in a dila form, a monopole form, or a loop form. The antenna form of the second antenna may be determined by the design requirements of the electronic device.

In some embodiments, the antenna forms of the third antenna and the fourth antenna may be determined by the design requirements of the electronic device. For example, the third antenna be in a dila form, or in a monopole form; and the fourth antenna be in a dila form, or in a monopole form.

In some embodiments, the length of the first antenna may be larger than the length of the second antenna, and the length of the third antenna may be larger than the length of the fourth antenna.

For example, the length of the first antenna may be 47 mm, the length of the second antenna may be 6 mm, the length of the third antenna may be 17 mm, and the length of the fourth antenna may be 8 mm.

In some embodiments, the interval between adjacent antennas may be the same. For example, every two adjacent antennas may be spaced apart with an interval of 1 mm. In other embodiments, the interval between adjacent antennas may be different. For example, the interval between the first antenna and the second antenna may be 1 mm, the interval between the second antenna and the third antenna may be 1 mm, and the interval between the first antenna and the fourth antenna may be 2.4 mm.

In practical applications, the length of the interval between two adjacent antennas may be related to the length of the short side of the metal frame and the lengths of the antennas disposed on the short side of the metal frame. The length of the interval may not be limited to the values provided in the above embodiments.

Further, an antennas disposed on the short side of the metal frame may be located on the side surface of the short side of the metal frame, and the length of the interval from the antenna disposed on the side surface of the short side to the lower edge of the side surface that is close to the inner side of the electronic device may be set as 1.5 mm. The value may be related to the width of the side surface of the short side of the metal frame.

In some embodiments, the third antenna may be correspondingly disposed at a first corner of the metal frame, and the fourth antenna may be correspondingly disposed at a second corner of the metal frame. The first corner and the second corner may be opposite to each other with respect to the side surface of the short side. The first corner may be the position where the short side of the metal frame connects to the first long side, and the second corner may be the position where the short side of the metal frame connects to the second long side.

Further, the third antenna may have a portion disposed on the short side of the metal frame and another portion disposed on the long side adjacent to the short side. The fourth antenna may have a portion disposed on the short side of the metal frame and another portion disposed on the long side adjacent to the short side. The long side on which the third antenna is partially disposed may be different from the long side on which the fourth antenna is partially disposed.

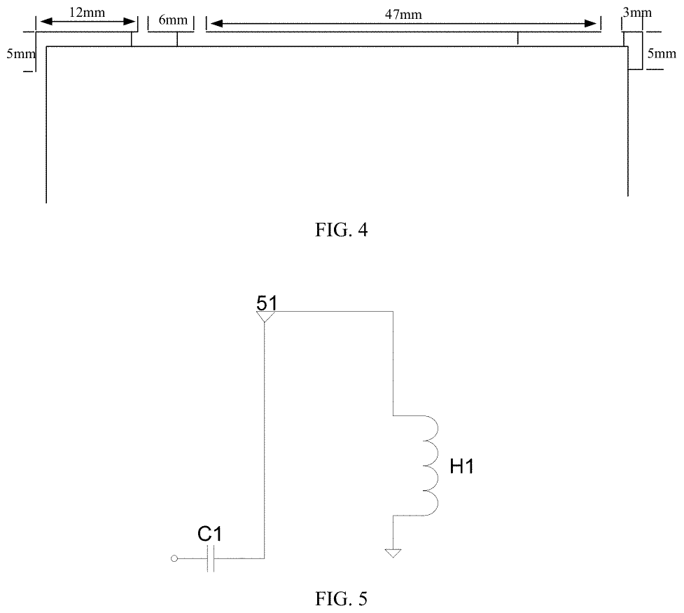

For example, in a case where the length of the third antenna is 17 mm, the length of the portion of the third antenna disposed on the short side of the metal frame may be 12 mm, and the length of the portion of the third antenna disposed on the long side of the metal frame may be 5 mm. In a case where the length of the fourth antenna is 8 mm, the length of the portion of the fourth antenna disposed on the short side of the metal frame may be 3 mm, and the length of the portion of the fourth antenna disposed on the long side of the metal frame may be 5 mm. FIG. 4 illustrates a schematic diagram of the structural sizes of an electronic device according to some embodiments of the present disclosure.

According to the disclosed electronic device, the electronic device may include a metal frame, and the metal frame may be used to provide one or more antennas. The one or more antennas may include a first antenna. The range of the operating frequency band of the first antenna may at least include a 5 GHz band, such that the electronic device may be able to support mobile communication network. The first antenna is disposed on a short side of the metal frame, and the first antenna is a first metal part on the side surface of the short side of the metal frame. The present solution provides at least a first antenna on the metal frame, and the range of the operating frequency band of the first antenna at least includes a 5 GHz band, such that the electronic device is provided with an antenna with an operating frequency band of 5 GHz on the metal frame. Therefore, the disclosed electronic device may be able to avoid using the LDS technology to implement an antenna with an operating frequency band of 5 GHz, and thus may save the production cost of the antenna.

The present disclosure provides an electronic device. FIG. 3 illustrates a schematic view of an electronic device according to some embodiments of the present disclosure.

Referring to FIG. 3, the electronic device may include a metal frame 31, a first antenna 32, a second antenna 33, a third antenna 34, and a fourth antenna 35. In addition to the same structure as described in the above embodiment, the range of the operating frequency band of the first antenna may be used to allow the electronic device to support at least two generations of mobile communication networks. The at least two generations of mobile communication networks may include the fifth generation mobile communication network. The first antenna may be one of the four antennas in the electronic device for supporting the fifth generation mobile communication network.

In some embodiments, the range of the operating frequency band of the first antenna may be used to allow the electronic device to support at least two generations of mobile communication networks, and the at least two generations of mobile communication networks may include the fifth generation mobile communication network and one or more other mobile communication networks. For example, besides including the fifth generation mobile communication network, the at least two generations of mobile communication networks may also include one or more of the fourth generation mobile communication network, the third generation mobile communication network, the second generation mobile communication network, or a sixth generation mobile communication network, and thus realize the multiplexing of the first antenna. The sixth generation mobile communication network may have an operating frequency band higher than a 5 GHz band that is adopted for the fifth generation mobile communication network.

In order to support the fifth generation mobile communication network, an electronic device may need at least four antennas, including a first antenna as described above, for supporting the fifth generation mobile communication network.

For example, the operating frequency band of the first antenna may cover a range approximately from 0.6 GHz to 5 GHz.

In some embodiments, the operating frequency band of the fourth antenna may be used to allow the electronic device to support the fifth generation mobile communication network, and the fourth antenna may be one of the four antennas in the electronic device for supporting the fifth generation mobile communication network.

In a case where the operating frequency band of the fourth antenna is also able to allow the electronic device to support the fifth generation mobile communication network, the fourth antenna may also be one of the four antennas described above. For example, the operating frequency band of the fourth antenna may cover a range approximately from 3.3 GHz to 5 GHz.

In some embodiments, the operating frequency band of the second antenna may be used to allow the electronic device to support a first type WiFi. The first type WiFi may be a 5G WiFi, and accordingly, the operating frequency band of the second antenna may cover a range approximately from 5.1 GHz to 5.9 GHz.

In some embodiments, the operating frequency band of the third antenna may be used to support the global positioning system (GPS) and a second type WiFi. The second type WiFi may be a 2G4 WiFi (WiFi2G4). Corresponding to the operating frequency band of the third antenna supporting the GPS and the second type WiFi, the operating frequency band of the third antenna may cover a range approximately from 1.5 GHz to 2.5 GHz.

Further, FIG. 5 illustrates a schematic circuit diagram of a fourth antenna according to some embodiments of the present disclosure. Referring to FIG. 5, the fourth antenna may include an inductor H1, a capacitor C1, and a feeding point 51. In some embodiments, the inductor H1 may be aperture1.3 nH, and the capacitor C1 may be 0.25 pF.

In some embodiments, the inductor H1 may be disposed between the feeding point 51 of the fourth antenna and an end of the fourth metal part that is used to connect the feeding point 51. The inductor H1 may be used to reduce the coupling between the fourth antenna and other antennas adjacent to the fourth antenna.

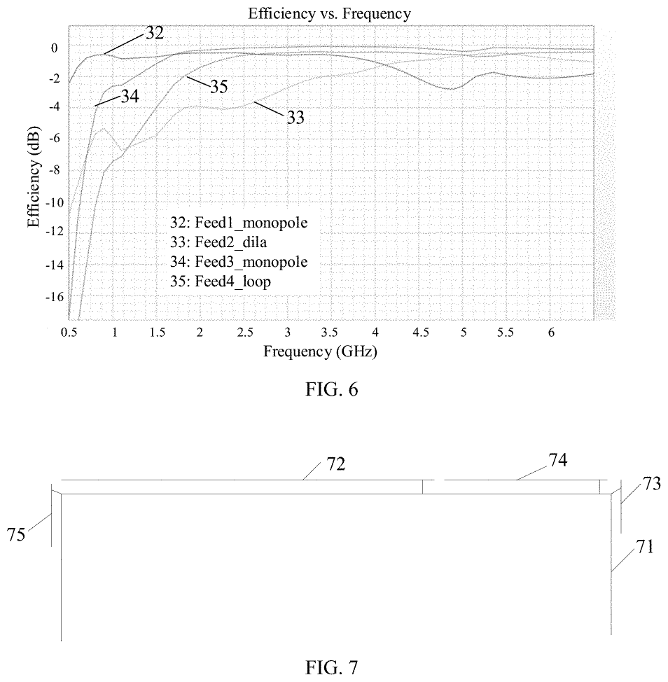

Further, different antennas may have different operating efficiencies in different frequency ranges. FIG. 6 illustrates an operation-efficiency graph according to some embodiments of the present disclosure. Referring to FIG. 6, the first antenna 32 may be in a monopole form, the second antenna 33 may be in a dila form, the third antenna 34 may be in a monopole form, and the fourth antenna 35 may be in a loop form. In FIG. 6, the vertical axis corresponds to the efficiency of an antenna, and the horizontal axis corresponds to the operating frequency of an antenna.

As indicated in FIG. 6, for different antenna forms, different operating frequencies may correspond to different efficiencies. Therefore, In some embodiments, when determining the antenna form and the operating frequency band for an antenna, the operating frequency band and the antenna form that correspond to the highest efficiency may be selected.

According to the disclosed electronic device, the electronic device may include a metal frame, and the metal frame may be used to provide one or more antennas. The one or more antennas may include a first antenna. The range of the operating frequency band of the first antenna may at least include a 5 GHz band, such that the electronic device may be able to support mobile communication network. The first antenna is disposed on a short side of the metal frame, and the first antenna is a first metal part on the side surface of the short side of the metal frame. The present solution provides at least a first antenna on the metal frame, and the range of the operating frequency band of the first antenna at least includes a 5 GHz band, such that the electronic device is provided with an antenna with an operating frequency band of 5 GHz on the metal frame. Therefore, the disclosed electronic device may be able to avoid using the LDS technology to implement an antenna with an operating frequency band of 5 GHz, and thus may save the production cost of the antenna.

The present disclosure provides an electronic device. FIG. 7 illustrates a schematic view of an electronic device according to some embodiments of the present disclosure.

Referring to FIG. 7, the electronic device may include a metal frame 71, a first antenna 72, a second antenna 73, a third antenna 74, and a fourth antenna 75. In some embodiments, the first antenna 72 and the third antenna 73 may be both disposed on a short side of the metal frame 71 of the electronic device as a first metal part and a second metal part, respectively on the side surface of the short side of the metal frame 71. The second antenna 73 may be disposed on a first long side of the metal frame 71 of the electronic device and may be adjacent to the second metal part formed by the third antenna 74. The fourth antenna 75 may be disposed on a second long side of the metal frame 71 of the electronic device and may be adjacent to the first metal part formed by the first antenna 72.

In some embodiments, the feeding point of the second antenna 73 may be disposed at a first corner of the metal frame, and the feeding point of the fourth antenna 75 may be disposed at a second corner of the metal frame. The first corner and the second corner may be opposite to each other with respect to the side surface of the short side. The first corner may be the position where the short side of the metal frame connects to the first long side, and the second corner may be the position where the short side of the metal frame connects to the second long side.

In some embodiments, the length of the first antenna may be larger than the length of the second antenna, and the length of the third antenna may be larger than the length of the fourth antenna.

Further, the operating frequency band of the first antenna 72 may be used to allow the electronic device to support at least two generations of mobile communication networks.

In some embodiments, the at least two generations of mobile communication networks supported by the electronic device may not include the fifth generation mobile communication network. The at least two generations of mobile communication networks may include the fourth generation mobile communication network, the third generation mobile communication network, or the second generation mobile communication network. Corresponding to the at least two generations of mobile communication networks including the fourth generation mobile communication network, the third generation mobile communication network, and the second generation mobile communication network, but not including the fifth generation mobile communication network, the operating frequency band of the first antenna 72 may cover a range approximately from 0.6 GHz to 2.7 GHz, and the antenna form adopted for the first antenna 72 may be the monopole form.

In some embodiments, the operating frequency band of the second antenna 73 may be used to allow the electronic device to support a first type WiFi. The first type WiFi may be a 5G WiFi, and accordingly, the operating frequency band of the second antenna may cover a range approximately from 5.1 GHz to 5.9 GHz.

In some embodiments, the operating frequency band of the third antenna 74 may be used to support the GPS and a second type WiFi. The second type WiFi may be a 2G4 WiFi (WiFi2G4). Corresponding to the operating frequency band of the third antenna supporting the GPS and the second type WiFi, the operating frequency band of the third antenna may cover a range approximately from 1.5 GHz to 2.5 GHz, and the corresponding antenna form may be the monopole form.

In some embodiments, the operating frequency band of the fourth antenna 75 may be used to support the fifth mobile communication network, and the fourth antenna 75 may be one of the four antennas in the electronic device for supporting the fifth generation mobile communication network.

FIG. 8 illustrates a schematic circuit diagram of a matching circuit according to some embodiments of the present disclosure. Referring to FIG. 8, the matching circuit of the electronic device may include a device body 81, a first antenna 82, a second antenna 83, a third antenna 84, and a fourth antenna 85. In some embodiments, the connection point between the device body 81 and the first antenna 82 may be the feeding point 821 of the first antenna 82, the connection point between the device body 81 and the second antenna 83 may be the feeding point 831 of the second antenna 83, the connection point between the device body 81 and the third antenna 84 may be the feeding point 841 of the third antenna 84, and the connection point between the device body 81 and the fourth antenna 85 may be the feeding point 851 of the fourth antenna 85.

Further, the analog signal source of the first antenna 82 may be analog signal source 822, the analog signal source of the second antenna 83 may be analog signal source 832, the analog signal source of the third antenna 84 may be analog signal source 842, and the analog signal source of the fourth antenna 85 may be analog signal source 852.

In some embodiments, because the third antenna 84 may be able to allow the electronic device to support the fifth generation mobile communication network, the GPS, and a second type WiFi, the third antenna 84 may thus have two analog signal sources. For example, a first analog signal source of the third antenna 84 may be an analog signal source corresponding to the second type WiFi, and a second analog signal source of the third antenna 84 may be an analog signal source corresponding to the fifth generation mobile communication network 5G and the GPS.

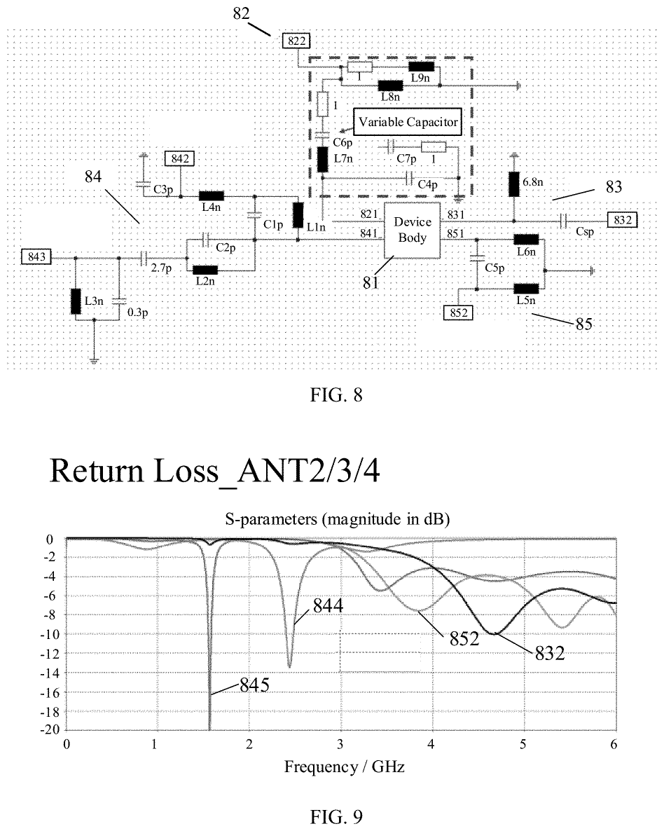

FIG. 9 illustrates a return-loss graph according to some embodiments of the present disclosure. Referring to FIG. 9, the return-loss curves corresponding to the second antenna 83, the third antenna 84, and the fourth antenna 85 are displayed, and the vertical axis corresponds to the return loss while the horizontal axis corresponds to the frequency of the antenna. In some embodiments, the second antenna 83 may have a signal source 832, the third antenna 84 may have a first signal source 844 and a second signal source 845, and the fourth antenna 85 may have a signal source 852. Correspondingly, the return-loss curves corresponding to the signal source 832, the first signal source 844, the second signal source 845, and the signal source 852 are illustrated in FIG. 9. Therefore, when determining the antenna frequency band for an antenna, the frequency band corresponding to a return loss below a predetermined value may be selected.

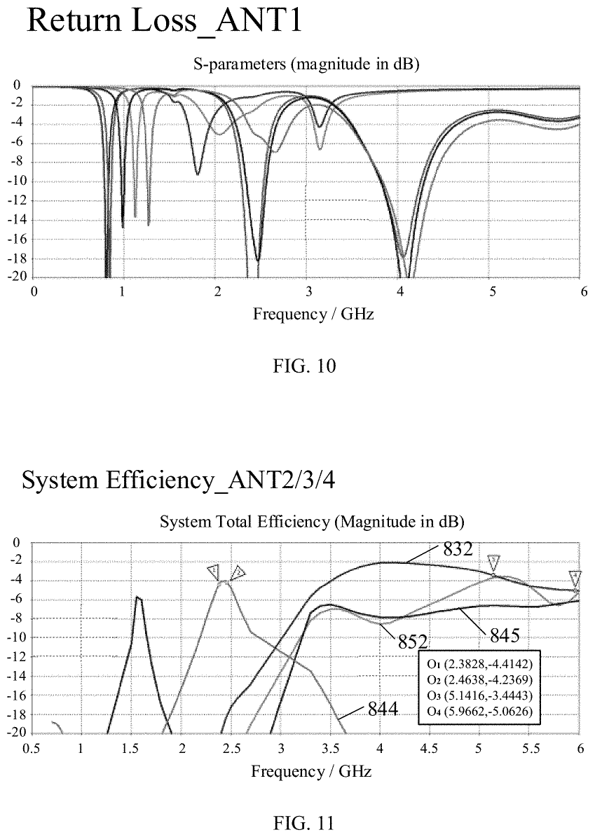

Referring to FIG. 8, in the matching circuit, the antenna circuit corresponding to the first antenna 82 may include a variable capacitor, e.g. C6p. By adjusting the capacitance of the variable capacitor, the operating frequency band of the first antenna may be changed. FIG. 10 illustrates a return-loss graph of a first antenna according to some embodiments of the present disclosure. Referring to FIG. 10, the return loss corresponding to different operating frequency band of the first antenna may be different.

FIG. 11 illustrates an operation-efficiency graph according to some embodiments of the present disclosure. Referring to FIG. 11, the operation efficiencies corresponding to the second antenna 83, the third antenna 84, and the fourth antenna 85 are displayed, and the vertical axis corresponds to the operation efficiency while the horizontal axis corresponds to the frequency of the antenna. In some embodiments, the second antenna 83 may have a signal source 832, the third antenna 84 may have a first signal source 844 and a second signal source 845, and the fourth antenna 85 may have a signal source 852. Correspondingly, the operation-efficiency curves corresponding to the signal source 832, the first signal source 844, the second signal source 845, and the signal source 852 are illustrated in FIG. 11. Therefore, when determining the antenna frequency band for an antenna, the frequency band corresponding to an operation efficiency above a predetermined value may be selected.

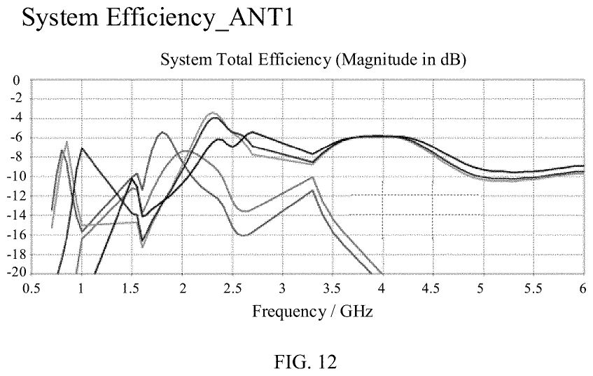

Referring to FIG. 8, the variable capacitor C6p may be adjusted in order to change the operating frequency band of the first antenna 82. As the operating frequency band of the first antenna 82 changes, the operation efficiency of the first antenna 82 may be different. FIG. 12 illustrates an operation-efficiency graph of a first antenna according to some embodiments of the present disclosure.

According to the disclosed electronic device, the electronic device may include a metal frame, and the metal frame may be used to provide one or more antennas. The one or more antennas may include a first antenna. The first antenna may be used to support at least two generations of mobile communication networks. The second antenna may be used to support a first type WiFi, the third antenna may be used to support the fifth generation mobile communication network, the GPS, and a second type WiFi, and the fourth antenna may be used to support the fifth generation mobile communication network. The solution provides support for the fifth generation mobile communication network through the third antenna and the fourth antenna disposed on the metal frame, such that the electronic device may be able to support the fifth generation mobile communication network through the metal frame. Therefore, the disclosed electronic device may be able to avoid using the LDS technology to implement an antenna for the fifth generation mobile communication network, and thus may save the production cost of the antenna.

The present disclosure provides an electronic device. FIG. 1 illustrates a schematic view of an electronic device according to some embodiments of the present disclosure.

Referring to FIG. 1, the electronic device may include a metal frame 11 and a first antenna 12. The metal frame 11 may be used to provide one or more antennas. The one or more antennas may include a first antenna, and the range of the operating frequency band of the first antenna may at least include a 5 GHz band to allow the electronic device to support the mobile communication network.

The one or more antennas may include at most ten antennas. That is, the maximum number of antennas provided by the metal frame 11 may be 10. In some embodiments, the number of the one or more antennas provided by the metal frame 11 may be ten or less, and four of the one or more antennas may be antennas that support the fifth generation mobile communication network. Further, other than the four of the one or more antennas allowing the electronic device to support the fifth generation mobile communication network, the remaining antennas of the one or more antennas may be used to allow the electronic device to support three different functions associated with connections with the electronic device.

In order to support the fifth generation mobile communication network, an electronic device may need at least four antennas for supporting the fifth generation mobile communication network. In a case where each antenna is not multiplexed to support two or more generations of mobile communication networks, the electronic device may include up to ten antennas. In a case where an antenna may be multiplexed to support at least two generations of mobile communication networks, the number of antennas in the electronic device may be nine, eight, seven, six, or any appropriate number.

According to the disclosed electronic device, the electronic device may include a metal frame, and the metal frame may be used to provide one or more antennas. The one or more antennas may include a first antenna. The range of the operating frequency band of the first antenna may at least include a 5 GHz band, such that the electronic device may be able to support mobile communication network. The present solution provides at least a first antenna on the metal frame, and the range of the operating frequency band of the first antenna at least includes a 5 GHz band, such that the electronic device is provided with an antenna with an operating frequency band of 5 GHz on the metal frame. Therefore, the disclosed electronic device may be able to avoid using the LDS technology to implement an antenna with an operating frequency band of 5 GHz, and thus may save the production cost of the antenna.

The embodiments provided in the present disclosure are described in a progressive manner. Each embodiment focuses on the differences from other embodiments, and the same or similar parts among these embodiments may be referred to each other. For the devices disclosed in the embodiments, the description may be relatively simple because of the corresponding relation between the devices and the disclosed methods. The details of the disclosed devices may be referred to the corresponding content in the description of the methods.

Those skilled in the art may further realize that the units and algorithm steps of the examples described with reference to the embodiments disclosed herein can be implemented by electronic hardware, computer software, or a combination of the two. To clearly illustrate the interchangeability of hardware and software, the components and steps of various examples have been generally described in terms of their functionality. Whether these functions are implemented by hardware or software depends on the specific application and the design constraints of the technical solutions. A person skilled in the art may use different methods to implement the described functions for each particular application. However, such implementation should not be considered as beyond the scope of the present disclosure.

The steps of the method or algorithm described in the embodiments disclosed herein may be implemented directly by hardware, a processor-executable software module, or a combination of the two. The software module may be located in random access memories (RAMs), internal memories, read-only memories (ROMs), electrically programmable ROMs, electrically erasable programmable ROM, registers, hard disks, removable disks, CD-ROMs, or other storage media that are well known in the field.

The description of the disclosed embodiments provided above ensures that those skilled in the art can realize or use the present disclosure. Various modifications to the embodiments are readily apparent to those skilled in the art. The general principles herein may be implemented in other embodiments without departing from the spirit or scope of the disclosure. Therefore, the present disclosure should not be limited to these embodiments described herein, but rather should be in accordance with the broadest scope consistent with the principles and the novel features disclosed herein.

What is claimed is:

1. An electronic device, comprising:
a metal frame, providing one or more antennas including a first antenna, wherein:
a range of an operating frequency band of the first antenna at least includes a 5 GHz band to allow the electronic device to support a mobile communication network.

2. The device according to claim 1, wherein:
the first antenna allows the electronic device to support a fifth generation mobile communication network; and
the first antenna is one of four antennas in the electronic device for supporting the fifth generation mobile communication network.

3. The device according to claim 2, wherein:
the one or more antennas further includes three antennas, other than the first antenna, that are included in the four antennas for supporting the fifth generation mobile communication network.

4. The device according to claim 2, wherein:
the operating frequency band of the first antenna allows the electronic device to support at least two generations of mobile communication networks, wherein the at least two generations of mobile communication networks include the fifth generation mobile communication network.

5. The device according to claim 2, wherein:
the operating frequency band of the first antenna covers a range approximately from 3 GHz to 6 GHz, wherein the operating frequency band of the first antenna at least allows the electronic device to support the fifth generation mobile communication network.

6. The device according to claim 1, wherein:
the first antenna is disposed on a short side of the metal frame; and
the first antenna is a first metal part on a side surface of the short side of the metal frame.

7. The device according to claim 6, wherein:
the one or more antennas includes four antennas, including the first antenna, a second antenna, a third antenna, and a fourth antenna, wherein:
the four antennas correspond to four metal parts on the metal frame, wherein the four metal parts include the first metal part corresponding to the first antenna, a second metal part corresponding to the second antenna, a third metal part corresponding to the third antenna, and a fourth metal part corresponding to the fourth antenna,
the four metal parts are discontinuously disposed, and
the four metal parts together form the side surface of the short side of the metal frame.

8. The device according to claim 7, wherein:
the first antenna is the first metal part, wherein:
both terminals of the first metal part are not grounded, a first feeding point of the first antenna is located on a first position of the first metal part, the first metal part is divided into a first branch and a second branch by the first feeding point, and the first branch and the second branch are asymmetric with each other;
the second antenna is the second metal part, wherein:
both terminals of the second metal part are not grounded, a second feeding point of the second antenna is located on a second portion of the second metal part, the second metal part is divided into a third branch and a fourth branch by the second feeding point, and the third branch and the fourth branch are symmetric to each other;
the third antenna is the third metal part, wherein:
a terminal of the third metal part is grounded, and another terminal of the third metal part serves as a third feeding point of the third antenna; and
the fourth antenna is the fourth metal part, wherein:
a terminal of the fourth metal part is grounded, and another terminal of the fourth metal part serves as a fourth feeding point of the fourth antenna.

9. The device according to claim 8, wherein:
a length of the first antenna is larger than a length of the second antenna; and
a length of the third antenna is larger than a length of the fourth antenna.

10. The device according to claim 9, wherein:
the third antenna corresponds to a first corner of the metal frame; and
the fourth antenna corresponds to a second corner of the metal frame, wherein:
the first corner and the second corner are opposite to each other with respect to the side surface of the short side.

11. The device according to claim 8, wherein:
the operating frequency band of the first antenna allows the electronic device to support at least two generations of mobile communication networks, wherein the at least two generations of mobile communication networks include the fifth generation mobile communication network, and the first antenna is one of the four antennas in the electronic device for supporting the fifth generation mobile communication network;
an operating frequency band of the fourth antenna allows the electronic device to support the fifth generation mobile communication network, wherein the fourth antenna is one of the four antennas in the electronic device for supporting the fifth generation mobile communication network;
an operating frequency band of the second antenna allows the electronic device to support a first type WiFi; and
an operating frequency band of the third antenna allows the electronic device to support a global positioning system (GPS) and a second type WiFi.

12. The device according to claim 8, wherein:
an operating frequency band of the third antenna allows the electronic device to support the fifth generation mobile communication network, a GPS, and a second type WiFi, wherein the third antenna is one of the four antennas in the electronic device for supporting the fifth generation mobile communication network;
an operating frequency band of the fourth antenna allows the electronic device to support the fifth generation mobile communication network, wherein the fourth antenna is one of the four antennas in the electronic device for supporting the fifth generation mobile communication network;
the operating frequency band of the first antenna allows the electronic device to support at least two generations of mobile communication networks; and
an operating frequency band of the second antenna allows the electronic device to support a first type WiFi.

13. The device according to claim 8, wherein:
the fourth antenna includes an inductor, wherein the inductor is disposed between the fourth feeding point of the fourth antenna and an end of the fourth metal part that connected to the fourth feeding point, wherein:
the inductor reduces a coupling between the fourth antenna and adjacent antennas.

14. The electronic device according to claim 1, wherein:
a quantity of the one or more antennas is about 10 or less, wherein:
four of the one or more antennas allows the electronic device to support the fifth generation mobile communication network; and
other than the four of the one or more antennas allowing the electronic device to support the fifth generation mobile communication network, remaining antennas of the one or more antennas allow the electronic device to support three different functions associated with connections with the electronic device.
